(19) United States
(12) Patent Application Publication
(10) Pub. No.: US 2021/0124641 A1
(43) Pub. Date: Apr. 29, 2021

(54) APPARATUS AND METHOD FOR INCORPORATING MULTI-ACTUATOR HARD DISK DRIVES INTO TRADITIONAL RAID ARRAYS

(71) Applicant: Microchip Technology Inc., Chandler, AZ (US)

(72) Inventor: Robert E. Caldwell, JR., Orlando, FL (US)

(73) Assignee: Microchip Technology Inc., Chandler, AZ (US)

(21) Appl. No.: 16/678,810

(22) Filed: Nov. 8, 2019

Related U.S. Application Data
(60) Provisional application No. 62/925,042, filed on Oct. 23, 2019.

(51) Int. Cl. G06F 11/10; G06F 3/06; G11B 20/12

(52) U.S. Cl. CPC G06F 11/1004; G06F 3/0604; G06F 3/0632; G11B 2020/1222; G06F 3/0689; G11B 20/1217; G06F 3/064

(57) ABSTRACT

A method for operating a storage controller to write to a group of multi-actuator disk drives includes receiving a data stream, performing RAID mapping to a preselected RAID level, organizing the data stream into at least one data stream, creating at least one parity data stream, organizing each data stream and parity data stream into blocks of data, dividing each data stream and each parity data stream into groups of blocks of data assigned to a logical unit representing a drive and an actuator, blocks of data from a data stream and parity stream assigned to a different drive, sequential groups of blocks of data assigned substantially equally to logical units representing actuators in each drive, providing each group of blocks of data to a target port associated with the drive to which it has been assigned, and sending each group of blocks of data from the target port.

### FIELD OF THE INVENTION

The present invention relates to disk drive storage and control of disk drive storage. More particularly, the present invention relates to multi-actuator disk drives and control of multi-actuator disk drives.

### BACKGROUND

Disk drive manufacturers are in the process of developing and releasing multi-actuator Hard Disk Drives (HDDs). These drives have the potential to multiply the current HDD bandwidth and input-output operations per second (IOPs) ratings of a conventional single actuator HDD by a factor equal to the number of actuators included in the HDD.

HDD actuators are the electromechanical arms that move the read/write heads to the relevant locations within the HDD. Until recently, all the read/write heads in the HDD have been attached to a single actuator. The single actuator has the capability to “seek” to any Logical Block Address (LBA) on the HDD. The conventional HDD presents a single Logical Unit Number (LUN), LUN 0, to a host initiator. Multi-actuator HDDs divide the total LBA range of the device into roughly equal portions, one for each actuator. Each actuator can only access its “portion” of the LBA range. Each actuator represents a separate LUN within the HDD.

The first examples of multi-actuator HDDs will be dual actuator. Dual actuator hard disk drives (DAHDDs) use two independent stacked actuators with each actuator addressing a separate disk of the DAHDD, each disk having a storage capacity of approximately one-half of the total HDD LBA space. These actuators will be represented as LUN 0 and LUN 1 of the HDD. As additional actuators may be added in the future, this addressing scheme is likely to continue.

A storage controller allows multiple disk drives to be aggregated into RAID (Redundant Array of Independent Disks) arrays. The RAID arrays (or portions thereof) are in turn presented through the host port of the storage controller as virtual logical units with their own logical unit numbers. Many RAID array configurations provide some level of fault tolerance allowing one or more logical units within the array to fail while maintaining stored data via various mathematical redundancy methods.

### BRIEF DESCRIPTION

In accordance with an aspect of the invention, a method for operating a storage controller to aggregate a group of multi-actuator disk drives in a multi-actuator disk drive system includes receiving in the storage controller a data stream including data to be written to the group of multi-actuator disk drives, performing RAID mapping across the group of multi-actuator disk drives on the data stream to a preselected RAID level, organizing the data stream into at least one data stream, the number of data streams selected to implement the preselected RAID level, creating at least one parity data stream, the number of parity data streams selected to implement the preselected RAID level, organizing each of the at least one data stream and each of the at least one parity data stream into blocks of data, dividing each of the at least one data stream and each of the at least one parity data stream into groups of blocks of data assigned to a logical unit representing an individual actuator of an individual multi-actuator disk drive of the group of multi-actuator disk drives, blocks of data from the of the at least one data stream assigned to the logical unit representing a different multi-actuator disk drive from that assigned to each of the at least one parity data stream, sequential ones of the groups of blocks of data of each of the of the at least one data stream and the at least one parity data stream assigned substantially equally to logical units representing different actuators in each individual multi-actuator disk drive, providing each group of blocks of data to a target port in the storage controller associated with the multi-actuator disk drive to which it has been assigned, and sending each group of blocks of data from the target port in the storage controller.

In accordance with an aspect of the invention, dividing each of the at least one data stream and each of the at least one parity data stream into groups of blocks of data includes dividing each of the at least one data stream and each of the at least one parity data stream such that each of the groups of blocks of data have an equal number of data block regions.

In accordance with an aspect of the invention, creating at least one parity data stream incudes creating a parity data stream that is a function of data from more than one data stream.

In accordance with an aspect of the invention, organizing each of the at least one data stream and each of the at least one parity data stream into blocks of data includes organizing each of the at least one data stream and each of the at least one parity data stream into up to chunk size groups of blocks of data.

In accordance with an aspect of the invention, the chunk size is chosen to be less than one half of an average write request size.

In accordance with an aspect of the invention, the method further includes issuing read commands to read groups of blocks of data from the group of multi-actuator disk drives. receiving groups of blocks of data at the storage controller, each group of blocks of data associated with the logical unit representing the individual actuator in the individual multi-actuator disk drive, each group of blocks of data associated with the individual multi-actuator disk drive being received at the respective assigned target port, separately interleaving the sequential ones of the groups of blocks of data received in each assigned target port from all of the individual actuators in the associated multi-actuator disk drive, and performing RAID mapping to assemble the separately interleaved groups of blocks of data from each multi-actuator disk drive into a single data stream in an order implementing mapping of the preselected RAID level.

In accordance with an aspect of the invention, receiving groups of blocks of data in the storage controller includes receiving chunk size groups of blocks of data at the respective assigned target port in the storage controller.

In accordance with an aspect of the invention, assembling the separately interleaved groups of blocks of data from each multi-actuator disk drive into the single data stream in an order implementing mapping of the preselected RAID level includes identifying first groups of blocks of data representing a data stream and identifying second groups of data representing a parity data stream, and assembling the first groups of blocks of data representing the data stream into the single data stream.

In accordance with an aspect of the invention, a storage controller to control a group of multi-actuator disk drives in a multi-actuator disk drive system, the storage controller comprising a host port and target ports is configured to receive at the host port a data stream including data to be written to the group of multi-actuator disk drives, perform RAID mapping across the group of multi-actuator disk drives on the data stream to a preselected RAID level, organize the data stream into at least one data stream, the number of data streams selected to implement the preselected RAID level, create at least one parity data stream, the number of parity data streams selected to implement the preselected RAID level, organize each of the at least one data stream and the at least one parity data stream into blocks of data, divide each of the at least one data stream and each of the at least one parity data stream into groups of blocks of data assigned to a logical unit representing an individual actuator of an individual multi-actuator disk drive of the group of multi-actuator disk drives, blocks of data from the of the at least one data stream assigned to the logical unit representing a different multi-actuator disk drive from that assigned to each of the at least one parity data stream, sequential ones of the groups of blocks of data of each of the of the at least one data stream and the at least one parity data stream assigned substantially equally to logical units representing different actuators in each individual multi-actuator disk drive, provide each group of blocks of data to a respective one of the target ports in the storage controller associated with multi-actuator disk drive to which it has been assigned, and send each group of blocks of data from the target port in the storage controller.

In accordance with an aspect of the invention, the division of each of the at least one data stream and each of the at least one parity data stream into groups of blocks of data includes dividing each of the at least one data stream and each of the at least one parity data stream such that each of the groups of blocks of data have an equal number of data block regions.

In accordance with an aspect of the invention, the storage controller is configured to create at least one parity data stream comprises creating a parity data stream that is a function of data from more than one data stream.

In accordance with an aspect of the invention, the organization of each of the at least one data stream and each of the at least one parity data stream into blocks of data includes organizing each of the at least one data stream and each of the at least one parity data stream into up to chunk size groups of blocks of data.

In accordance with an aspect of the invention, the storage controller is configured to choose the chunk size to be less than one half of an average write request size.

In accordance with an aspect of the invention, the storage controller is further configured to receive groups of blocks of data at the storage controller, each group of blocks of data associated with the logical unit representing the individual actuator in the individual multi-actuator disk drive, each group of blocks of data associated with the individual multi-actuator disk drive being received at the respective assigned target port, separately interleave the sequential ones of the groups of blocks of data received in each assigned target port from all of the individual actuators in the associated multi-actuator disk drive, and perform RAID mapping to assemble the separately interleaved groups of blocks of data from each multi-actuator disk drive into a single data stream in an order implementing mapping of the preselected RAID level.

In accordance with an aspect of the invention, the storage controller is configured to receive chunk size groups of blocks of data at the respective assigned target port in the storage controller.

In accordance with an aspect of the invention, the storage controller is configured to perform RAID mapping to assemble the separately interleaved groups of blocks of data from each multi-actuator disk drive into the single data stream in the order implementing mapping of the preselected RAID level by identifying first groups of blocks of data representing a data stream and identifying second groups of data representing a parity data stream, and assembling the first groups of blocks of data representing the data stream into the single data stream.

a method for operating a storage controller to write data to a group of multi-actuator disk drives in a multi-actuator disk drive system includes receiving in the storage controller a data stream including data to be written to the group of multi-actuator disk drives, performing RAID mapping across the group of multi-actuator disk drives on the data stream to a preselected RAID level, organizing the data stream into at least one data stream, the number of data streams selected to implement the preselected RAID level, creating at least one parity data stream, the number of parity data streams selected to implement the preselected RAID level, organizing each data stream and parity data stream into blocks of data, dividing each data stream and each parity data stream into groups of blocks of data assigned to a logical unit representing an individual multi-actuator disk drive and an actuator in the individual multi-actuator disk drive, blocks of data from a data stream and parity stream assigned to a logical unit representing a different multi-actuator disk drive, sequential ones of the groups of blocks of data assigned substantially equally to logical units representing actuators in each individual multi-actuator disk drive, providing each group of blocks of data to a target port in the storage controller associated with the logical unit to which it has been assigned, and sending each group of blocks of data from the target port in the storage controller.

In accordance with an aspect of the invention, dividing each data stream and each parity data stream provided to each multi-actuator disk drive into groups of blocks of data includes dividing each data stream such that each of the groups of blocks of data have an equal number of data block regions.

In accordance with an aspect of the invention, creating at least one parity data stream Includes creating a parity data stream that is a function of data from a pair of data streams.

In accordance with an aspect of the invention, organizing each data stream and parity data stream into blocks of data includes organizing each data stream and parity data stream into up to chunk size groups of blocks of data.

In accordance with an aspect of the invention, the chunk size is chosen to be less than one half of an average write request size.

In accordance with an aspect of the invention, a method for operating a storage controller to process data read from a group of multi-actuator disk drives in a multi-actuator disk drive system configured to a preselected RAID level, includes receiving groups of blocks of data at a target port in the storage controller, each group of blocks of data associated with a logical unit representing a different multi-actuator disk drive and an individual actuator on that drive, sequential ones of the groups of blocks of data received substantially equally from logical units representing individual actuators in each individual multi-actuator disk drive, and assembling the groups of blocks of data into a single data stream in an order implementing mapping of the preselected RAID level.

In accordance with an aspect of the invention, receiving groups of blocks of data at a target port in the storage controller includes receiving chunk size groups of blocks of data at a target port in the storage controller.

In accordance with an aspect of the invention, assembling the groups of blocks of data into a single data stream in an order implementing mapping of the preselected RAID level includes identifying first groups of blocks of data representing a data stream and identifying second groups of data representing a parity data stream, and assembling the first groups of blocks of data representing the data stream into the single data stream.

In accordance with an aspect of the invention, a storage controller to control a group of multi-actuator disk drives in a multi-actuator disk drive system, the storage controller configured to receive in the storage controller a data stream including data to be written to the group of multi-actuator disk drives, perform RAID mapping across the group of multi-actuator disk drives on the data stream to a preselected RAID level, organize the data stream into at least one data stream, the number of data streams selected to implement the preselected RAID level, create at least one parity data stream, the number of parity data streams selected to implement the preselected RAID level, organize each data stream and parity data stream into blocks of data, divide each data stream and each parity data stream into groups of blocks of data assigned to a logical unit representing an individual multi-actuator disk drive and an actuator in the individual multi-actuator disk drive, blocks of data from a data stream and parity stream assigned to a logical unit representing a different multi-actuator disk drive, sequential ones of the groups of blocks of data assigned substantially equally to logical units representing actuators in each individual multi-actuator disk drive, provide each group of blocks of data to a target port in the storage controller associated with the logical unit to which it has been assigned, and send each group of blocks of data from the target port in the storage controller.

In accordance with an aspect of the invention, the storage controller is configured to divide each data stream and each parity data stream provided to each multi-actuator disk drive into groups of blocks of data comprises dividing each data stream such that each of the groups of blocks of data have an equal number of data block regions.

In accordance with an aspect of the invention, the storage controller is configured to create at least one parity data stream comprises creating a parity data stream that is a function of data from a pair of data streams.

In accordance with an aspect of the invention, the storage controller is configured to organize each data stream and parity data stream into blocks of data comprises organizing each data stream and parity data stream into up to chunk size groups of blocks of data.

In accordance with an aspect of the invention, the storage controller is configured to choose the chunk size to be less than one half of an average write request size.

In accordance with an aspect of the invention, the storage controller is further configured to receive groups of blocks of data at a target port in the storage controller, each group of blocks of data associated with a logical unit representing a different multi-actuator disk drive and an individual actuator on that drive, sequential ones of the groups of blocks of data received substantially equally from logical units representing individual actuators in each individual multi-actuator disk drive, and assemble the groups of blocks of data into a single data stream in an order implementing mapping of the preselected RAID level.

In accordance with an aspect of the invention, the storage controller is configured to receive chunk size groups of blocks of data at a target port in the storage controller.

In accordance with an aspect of the invention, the storage controller is configured to assemble the groups of blocks of data into a single data stream in an order implementing mapping of the preselected RAID level by identifying first groups of blocks of data representing a data stream and identifying second groups of data representing a parity data stream, and assembling the first groups of blocks of data representing the data stream into the single data stream.

### BRIEF DESCRIPTION OF THE DRAWING FIGURES

The invention will be explained in more detail in the following with reference to embodiments and to the drawing in which are shown:

FIG. 1 is a diagram that shows a RAID Storage Controller attached to two DAHDDs and configured into two RAID 1 arrays by the storage controller's RAID mapping software;

FIG. 2 is a simplified block diagram that illustrates a possible configuration of two RAID 1 arrays created on four LUNs and shows how the two RAID 1 arrays would be organized in a conventional way to employ multi-actuator disk drive storage;

FIG. 3 is a simplified block diagram that illustrates another possible configuration of two RAID 1 arrays created on four LUNs and shows how the two RAID 1 arrays would be organized in a conventional way to employ multi-actuator disk drive storage;

FIG. 4 is a simplified diagram that shows a configuration of two RAID 1 arrays created on four LUNs in accordance with an aspect of the present invention;

FIG. 5 is a diagram showing RAID 1 mapping for two dual actuator disk drives in accordance with an aspect of the present invention;

FIG. 6 is a diagram illustrating chunking used in a dual actuator disk drive in accordance with an aspect of the present invention;

FIG. 7 is a diagram illustrating a read/write request with chunking overlay to divide the request workload in accordance with an aspect of the present invention;

FIG. 8 is a diagram showing the dual actuator hard disk drive chunking algorithm distributing the read/write workload equitably between both actuators allowing simultaneous operation and maximizing performance in accordance with an aspect of the present invention;

FIG. 9 is a flowchart describing the flow of read/write operations for a pair of dual actuator disk drives in accordance with an aspect of the invention;

FIG. 10 is a diagram showing an example of chunking in a RAID 1 read or write operation to a virtual disk member VD0_{H};

FIG. 11 is a flow diagram showing a method for operating a storage controller to write data to a RAID array of multi-actuator disk drives in accordance with an aspect of the present invention; and

FIG. 12 is a drawing showing a method for operating a storage controller to process data read from a multi-actuator disk drive in accordance with an aspect of the present invention.

### DETAILED DESCRIPTION

Persons of ordinary skill in the art will realize that the following description is illustrative only and not in any way limiting. Other embodiments will readily suggest themselves to such skilled persons.

RAID arrays are configured by a user external to the storage controller through a user interface. The user, through the user interface, must create a RAID array from a list of available logical units (or logical unit numbers) that the attached multi-actuator HDDs present to the storage controller. Commonly-used RAID levels known to persons of ordinary skill in the art are RAID 0, RAID 1, RAID 5, and RAID 6. RAID 0 simply divides the data among multiple HDDs and does not provide for data recovery in the event of a drive failure, while the other RAID level schemes provide different levels of data recovery as is known in the art. The present invention relates to all RAID arrays that provide data recovery.

RAID 1 is a logical configuration made from two different logical units (LUs). RAID 1 is a mirroring scheme wherein each of the two LUs is a copy of the other. Writes sent to the RAID 1 array are duplicated to each LU. Reads to a RAID 1 array may be sent to either LU. A RAID 1 array can tolerate one logical unit failure. If one of the LU components fails, all reads and writes may be directed to the remaining LU.

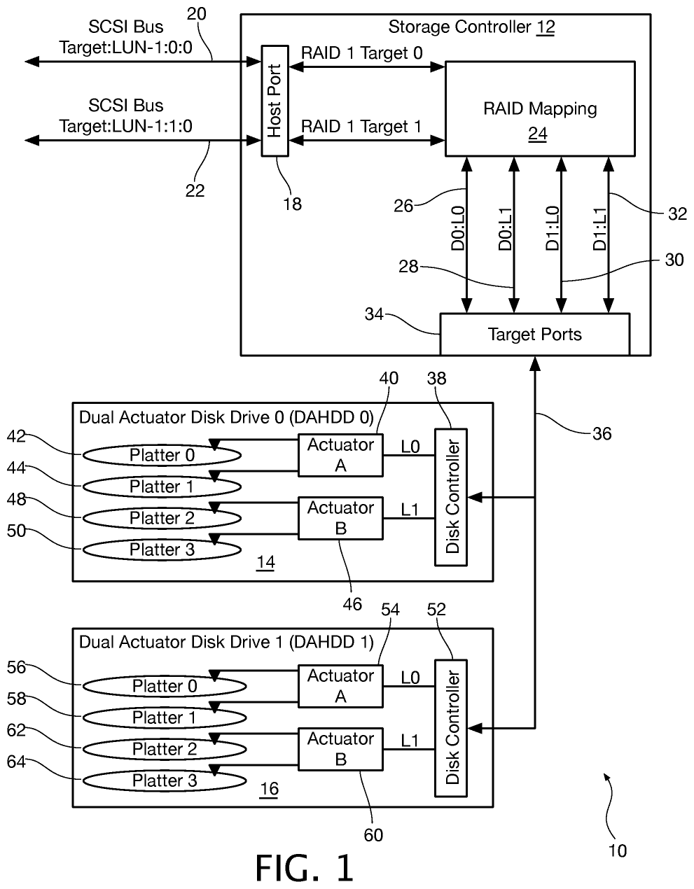

Referring now to FIG. 1, a block diagram shows a DAHDD system 10 including a RAID storage controller 12 attached to two DAHDDs, DAHDD 0 14 and DAHDD 1 16. While certain embodiments are being illustrated in relation to DAHDDs, it is to be understood that the teachings herein are applicable generally to multi-actuator HDDs, with a DAHDD being a particular embodiment thereof. The host port 18 in the storage controller 12 routes data for SCSI Bus:Target:LUN 1:0:0 shown at reference numeral 20 and SCSI Bus:Target:LUN 1:1:0 shown at reference numeral 22 to RAID mapping unit 24, which creates data streams D0:L0 D0:L1 D1:L0 and D1:L1 shown at reference numerals 26 through 32, respectively. The host port 18 represents the physical connection between the storage controller 12 and a host computer system (not shown).

The target ports 34 in the storage controller 12 direct data into, and out of, the storage controller 12 across connection 36 from the storage controller 12 to, and from, the DAHDDs 14 and 16. Each target port as this term is used herein is a PHY (physical connection) between the storage controller 12 and an individual disk drive unit 14 or 16.

The DAHDDs 14 and 16 each include two actuators each driving at least one platter. As shown in FIG. 1, DAHDD 0 14 includes a disk controller 38 coupled to actuator A 40. Actuator A 40 drives the signals that perform the reading and writing to platters 42 and 44. Similarly, the disk controller 38 is coupled to actuator B 46. Actuator B 46 drives the signals that perform the reading and writing to platters 48 and 50.

As shown in FIG. 1, DAHDD 1 16 includes a disk controller 52 coupled to actuator A 54. Actuator A 54 drives the signals that perform the reading and writing to platters 56 and 58. Similarly, the disk controller 52 is coupled to actuator B 60. Actuator B 60 drives the signals that perform the reading and writing to platters 62 and 64.

FIG. 1 shows that the four logical units presented by the DAHDDs 14 and 16 (DAHDD 0 L0 and L1 and DAHDD 1 L0 and L1) are configured into two RAID 1 arrays by the RAID mapping software 24 in the storage controller 12. The storage controller 12 then exposes the two RAID 1 arrays as logical units through the host port 18. A RAID 1 array is configured by choosing two available LUNs (or portions of those LUNs) and creating the RAID 1 array. The two DAHDDs 14 and 16 attached to the storage controller 12 in FIG. 1 expose a total of 4 LUNs to the storage controller 12 which are in turn presented as 4 available LUNs to the user. The user may create two RAID 1 arrays from the four available LUNs.

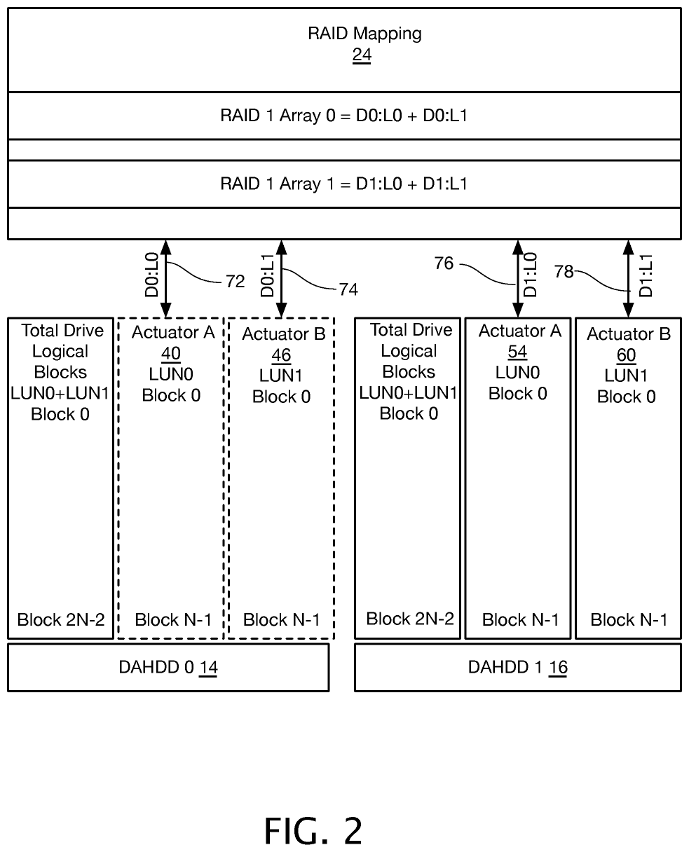

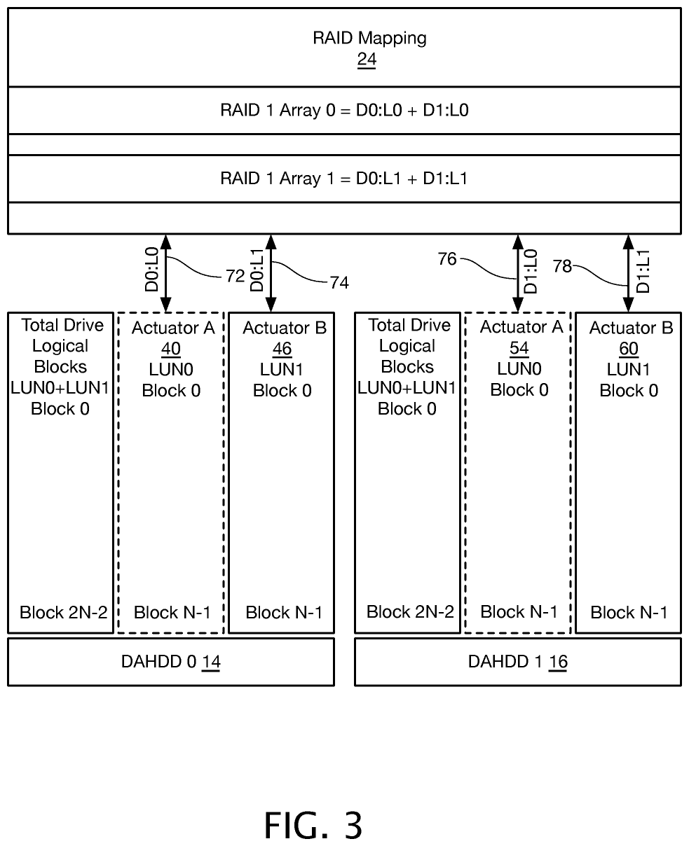

FIG. 2 and FIG. 3 are simplified block diagrams illustrating some possible configurations of two RAID 1 arrays created on four LUNs and show how the two RAID 1 arrays would be organized in a conventional way to employ multi-actuator disk drive storage. The depictions of DAHDD 0 and DAHDD 1 are abstractions of how the storage controller represents a disk. Each DAHDD is a disk unit with a total number of logical blocks equal to the sum of the logical blocks presented by each actuator. Each actuator presents its own number of blocks.

Referring now to FIG. 2, a diagram shows a RAID mapping where each RAID 1 array is created from two LUNs presented by the same DAHDD. The first RAID 1 array is defined as D0:L0+D0:L1, uses DAHDD 0 14, and presents the data stream D0:L0 at reference numeral 72 to actuator A 40 of DAHDD 0 14, and the data stream D0:L1 at reference numeral 74 to actuator B 46 of DAHDD 0 14 (both shown in dashed lines). The second RAID 1 array is defined as D1:L0+D1:L1, uses DAHDD 0 16, and presents the data stream D1:L0 at reference numeral 76 to actuator A 54 of DAHDD 1 16, and the data stream D 111 at reference numeral 78 to actuator B 60 of DAHDD 1 16 (both shown in solid lines). Each of the group of platters associated with actuator A and actuator B of both DAHDD 0 and DAHDD 1 have a total storage capacity of N blocks (block 0 through block N−1), resulting in a total storage capacity of 2N blocks (block 0 through block 2N−2).

This is not an acceptable mapping because it does not support the RAID 1 fault tolerance requirement of operation in face of a single LUN failure. Both LUNs of each RAID 1 in this case are dependent on the same electromechanical mechanism (either DAHDD 0 14 or DAHDD 1 16) which creates a single point of failure. If either disk DAHDD k 0 14 or DAHDD 1 16 fails, a RAID array will fail.

Referring now to FIG. 3, a diagram shows a RAID mapping where each RAID 1 is created from one of each of the LUNs presented by both DAHDD 0 and DAHDD 1. The first RAID 1 array is defined as D0:L0+D1:L0, and presents the data stream D0:L0 at reference numeral 72 to actuator A 40 of DAHDD 0 14, the data stream D1:L0 at reference numeral 76 to actuator A 54 of DAHDD 1 16 (both shown in dashed lines). The second RAID 1 array is defined as D0:L1+D1:L1, and presents the data stream D0:L1 at reference numeral 74 to actuator B 46 of DAHDD 0 16, and the data stream D1:L1 at reference numeral 78 to actuator B 60 of DAHDD 1 16 (both shown in solid lines).

As with the RAID 1 array depicted in FIG. 2, each of the group of platters associated with actuator A and actuator B of both DAHDD 0 and DAHDD 1 have a total storage capacity of N blocks (block 0 through block N−1), resulting in a total storage capacity of 2N blocks.

This is an acceptable mapping because it does support the RAID 1 fault tolerance requirement of operation in face of a single LUN failure. Either DAHDD 0 14 or DAHDD 1 16 may fail thus removing one LUN from each of the RAID 1 arrays. The surviving DAHDD will still contain one LUN for each of the two RAID 1 arrays.

The configuration shown in FIG. 3 is not optimal for DAHDD performance. External factors control the workload (read and/or write requests) sent to the RAID 1 arrays through the host port 18. In this configuration the user is responsible for managing and balancing the workload such that each RAID 1 can maintain enough reads and/or writes to simultaneously activate all of the available actuators.

The RAID configurations shown in FIG. 2 and FIG. 3 expose the problems with the currently available methods for configuring RAID 1 arrays with DAHDD. These problems are simply, maintaining the appropriate fault tolerance and providing a sufficiently balanced workload to insure optimal performance.

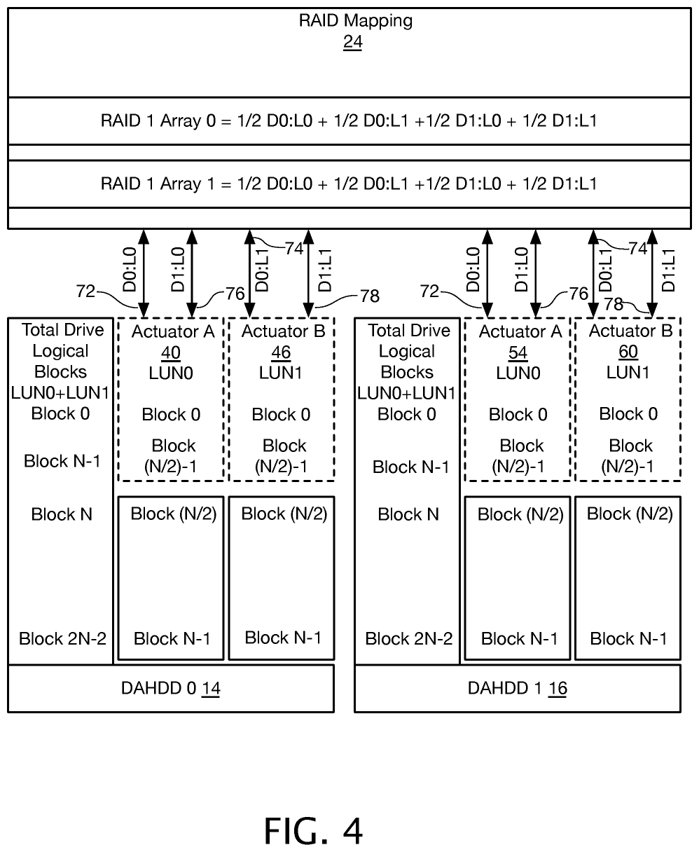

Referring now to FIG. 4, a simplified block diagram shows a configuration of two RAID 1 arrays created on four LUNs in accordance with an aspect of the present invention. FIG. 4 shows a RAID mapping where each RAID 1 is created from one half of each of the LUNs presented by both DAHDD 0 and DAHDD 1. The first RAID 1 array is defined as ½ D0:L0+½ D0:L1+½ D1:L0+½ D1:L1, and presents half of the data stream D0:L0 at reference numeral 72 to actuator A 40 of DAHDD 0 14, half of the data stream D0:L1 at reference numeral 74 to actuator B 46 of DAHDD 0 14, half of the data stream D1:L0 at reference numeral 76 to actuator A 54 of DAHDD 1 16, and half of the data stream D1:L1 at reference numeral 78 to actuator B of DAHDD 1 16 (all shown in dashed lines). The second RAID 1 array is also defined as ½ D0:L0+½ D0:L1+½ D1:L0+½ D1:L1, and presents the other half of the data stream D0:L0 at reference numeral 72 to actuator A 40 of DAHDD 0 14, the other half of the data stream D0:L1 at reference numeral 74 to actuator B 46 of DAHDD 0 14, the other half of the data stream D1:L0 at reference numeral 76 to actuator A 54 of DAHDD 1 16, and the other half of the data stream D1:L1 at reference numeral 78 to actuator B of DAHDD 1 16 (all shown in solid lines).

The total storage capacity of each of DAHDD 0 and DAHDD 1 in the RAID 1 array depicted in FIG. 4 is 2N blocks (block 0 through block 2N−2). Each of the LUNs created in each of the group of platters associated with actuator A and actuator B of both DAHDD 0 and DAHDD 1 in the RAID 1 array depicted in FIG. 4 have a total storage capacity of N/2 blocks (block 0 through block N/2−1 and block N/2 through block N−1), resulting in a total storage capacity of 2N blocks (block 0 through block 2N−2).

The configuration of two RAID 1 arrays created on four LUNs in accordance with the aspect of the present invention in FIG. 4 shows that both RAID 1 arrays utilize all the actuators on all the DAHDDs included in the arrays. This configuration optimizes the simultaneous actuator usage and provides the highest available DAHDD performance multiplier for any given operation.

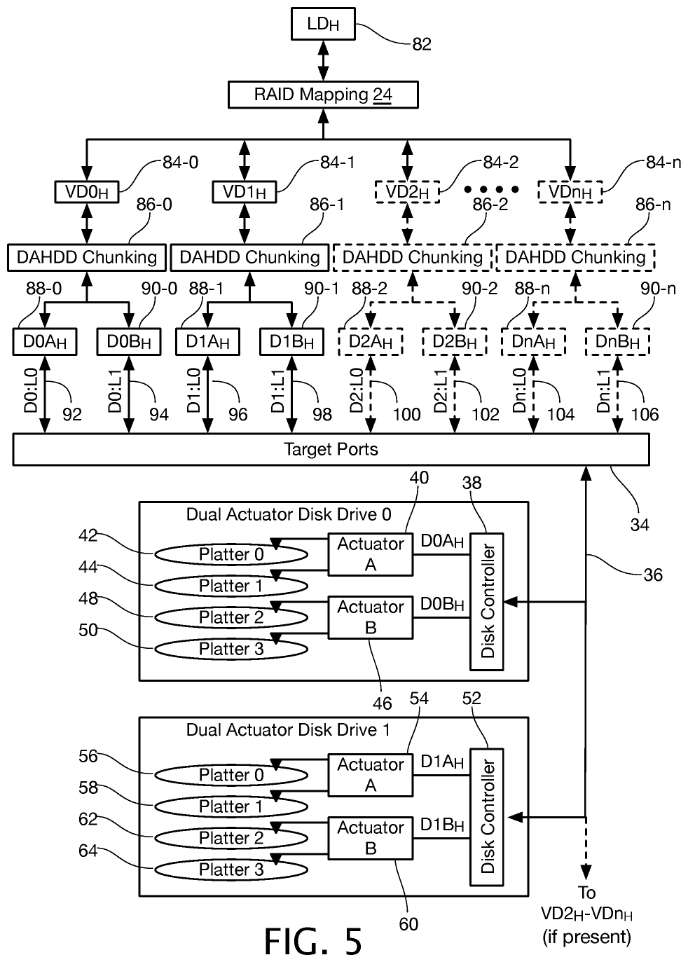

Referring now to FIG. 5, a diagram shows details of the RAID mapping used in FIG. 4. The diagram shows the data distribution for a single one of the RAID 1 arrays of FIG. 4. Persons of ordinary skill in the art will readily appreciate that FIG. 4 can be logically extended to any number of RAID 1 arrays using the same set of DAHDDs. Such skilled persons will also appreciate that the architecture of FIG. 5 can accommodate higher RAID levels.

In FIG. 5, the storage controller presents a logical disk drive formed by the RAID 1 array. The host application reads and writes data to this logical disk drive. The data for the read or write request from the host is represented by LD_{H} at reference numeral 82. The RAID 1 mapping software 24 defines that there are two copies of LD_{H} in the RAID 1 array. In RAID 1, the fact that there are two copies of LD_{H} performs the function of parity data. To maintain the required fault tolerance of the RAID 1 array, the two copies must reside on different DAHDDs. If one of the DAHDDs fails, the data is recoverable from the other. The RAID mapping software 24 may implement any preselected RAID level as is known in the art. The two data copies are represented by the virtual disk drives VD0_{H} and VD1_{H} shown, respectively, at reference numerals 84-0 and 84-1. For RAID 1, write requests from the host will be written to both disk drives. For read requests from the host, the request may be fulfilled by either disk drive. An independent algorithm as part of RAID 1 mapping software 24 is responsible for designating which disk drive the data should be written to, or read from, and assigning that data to the designated drive. The details of that algorithm are not within the scope of the invention, but is known to those skilled in the art.

The present invention is easily extended to a larger number of virtual disk drives as shown by the additional virtual drives VD2_{H} through VDn_{H} shown, respectively, at reference numerals 84-2 through 84-n.

VD0_{H} and VD1_{H} are each connected to a different DAHDD through the storage controller target ports 34. The DAHDD chunking layer shown at reference numerals 86-0 and 86-1 respectively manages the data distribution of the virtual disk drives, VD0_{H} and VD1_{H} to the DAHDDs. The data distribution to the four storage targets presented by the two DAHDDs is represented by D0A_{H}, D0B_{H}, D1A_{H} and D1B_{H} at reference numerals 88-0, 90-0, 88-1, and 90-1, respectively. DAHDD chunking layers 86-0, 86-1, divide the data stream through VD0_{H} and VD1_{H} equally so that both actuators of each DAHDD can operate simultaneously to achieve optimal performance of the DAHDDs. The additional dashed-line portions of the DAHDD chunking layer shown at reference numerals 86-2 through 86-n and the additional data distribution to possible additional storage targets presented by the additional DAHDDs is represented by D2A_{H}, D2B_{H} through DnA_{H} and DnB_{H} will be appreciated by persons of ordinary skill in the art and are shown for use in embodiments that employ more than two DAHDDs.

Data streams D0:L0, D0:L1, D1:L0, DELL D2:L0, D2:L1, Dn:L0, Dn:L1 are shown at reference numerals 92, 94, 96, 98, 100, 102, 104, and 106, respectively, being provided to the target ports 34 of the storage controller 12.

The read process is the reverse of the write process as shown by the bi-directional arrows in FIG. 5. Data from the two disk drives is received at the target ports 34. Data from each actuator (D0A_{H}, D0B_{H}, D1A_{H} and D1B_{H}) of the disk drives is interleaved in the DAHDD Chunking process 86-0 and 86-1 as will be discussed with reference to FIG. 8. The divided reconstructed data streams (VD0_{H} and VD1H) are reassembled by the RAID mapping software 24 into the original data stream that was written to the disk drives in accordance with the preselected RAID level. As noted, the number of disk drives used in any RAID array will be selected according to the RAID level desired.

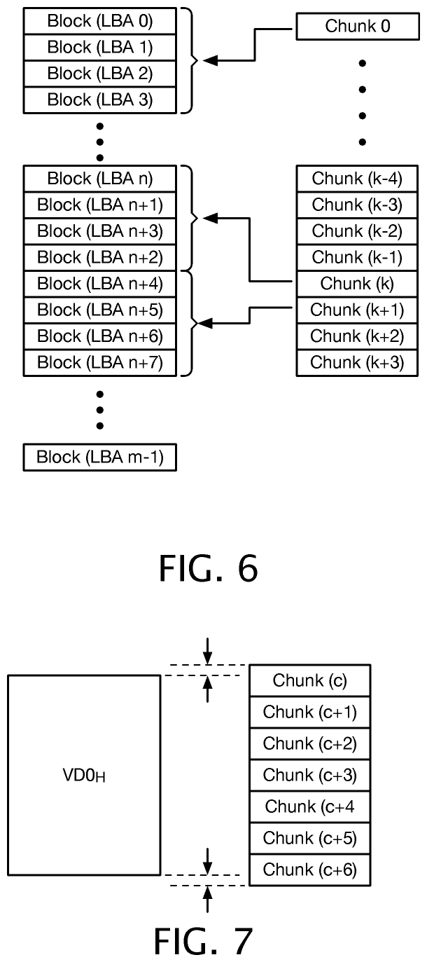

Referring now to FIG. 6, a diagram defines some terms used to describe DAHDD chunking A block is the smallest addressable storage location on a disk drive. A plurality of sequential blocks starting at block (LBA 0) are shown in a column at the left side of FIG. 6. The block size (block size) is some number of bytes defined by information supplied by the disk drive, typically by disk drive firmware. Each block is associated with a Logical Block Address (LBA). The number of blocks on a disk drive is supplied by the disk drive (capacity). In this case the capacity of the disk drive is M blocks [0 . . . (m−1)] with block (LBA m−1) shown as the last block in FIG. 6. In a DAHDD, each actuator has its own domain of blocks (LBA space) defined by the platters associated with each actuator. A disk drive actuator may travel to any LBA (seek) within its LBA space.

A chunk is defined as a contiguous number of blocks. Sequential chunks are shown in a column at the right side of FIG. 6. Chunk 0 extends from block LBA 0 through block LBA (3), chunk k extends from block LBA n (where n MOD 4 is equal to 0) through block LBA (n+3), and chunk (k+1) extends from block LBA (n+4) through block LBA (n+7), and so on.

The number of blocks in a chunk is arbitrary but all chunks are the same size. An optimal chunk size is preferably chosen to be less than one half of an average I/O request (i.e., WRITE request and READ request) size. This assures that more than half of the I/O requests would utilize both actuators. In the illustrative non-limiting example of FIG. 6, chunks are defined as four contiguous blocks. All chunks are aligned such that the first block of the first chunk must reside at the first block within any block range defined as a storage space (chunk 0).

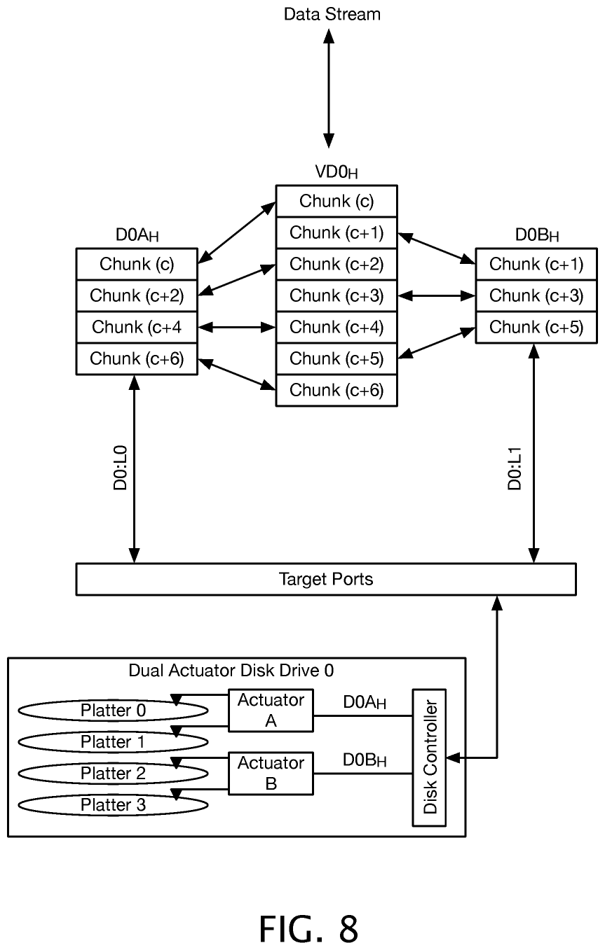

Using the VD0_{H} as an example, the position of blocks within a chunk may start or end at a block position that is not coincident with the edge of a chunk as shown in FIG. 7 where the VD0_{H} lies within but is not coincident with the boundaries of chunk (c) and chunk (c+6) as shown by arrows at the top and bottom of VD0_{H}. To optimize DAHDD performance, the number of blocks in a chunk should preferably be defined to be less than one-half of the average read/write request size intended for the RAID array. This insures that the DAHDD chunking algorithm will most likely activate both actuators simultaneously by providing chunked data streams to both actuators.

The result of this configuration is that any read or write request for any number of blocks greater than the chunk size from the RAID 1 mapping layer (VD0_{H} and VD1_{H}) will fit into more than one chunk. This allows DAHDD chunking to divide the workload into chunks by using a chunking overlay as shown in FIG. 7.

VD0_{H} is a virtual representation of the chunked data stream to, or from, the dual actuator disk drive 0 as shown in FIG. 8. The chunked data stream VD0_{H} is shown in the center of FIG. 8. The chunks are alternately routed to D0A_{H} shown at the left side of FIG. 8 and D0B_{H} shown at the right side of FIG. 8. The DAHDD chunking layer 86-0 . . . 86-n distributes the chunks of blocks represented in FIG. 7 to Disk 0 actuators A and B (D0A_{H} and D0B_{H}). The chunk mapping algorithm of the DAHDD chunking layer 86-0 . . . 86-n for one dual-actuator disk drive shown in FIG. 8 is trivial. Even numbered chunks are routed to D0A_{H} and odd numbered chunks are routed to D0B_{H}. This chunk mapping algorithm is used to distribute the “chunked” data stream among the actuators when writing the data to the disk drives and is used in reverse to re-assemble the chunks into the data stream VD0_{H} by interleaving them when reading data from the disk drives. Persons of ordinary skill in the art will readily appreciate that the chunking algorithm depicted in FIG. 8 is readily extended to additional multi-actuator disk drives.

FIG. 8 shows how the DAHDD chunking algorithm can distribute the read/write workload equitably between both actuators allowing simultaneous operation and maximizing performance. In order to process any sufficiently large read or write request to the virtual disk drive (VD0_{H}), both actuators of DAHDD Disk 0 must operate.

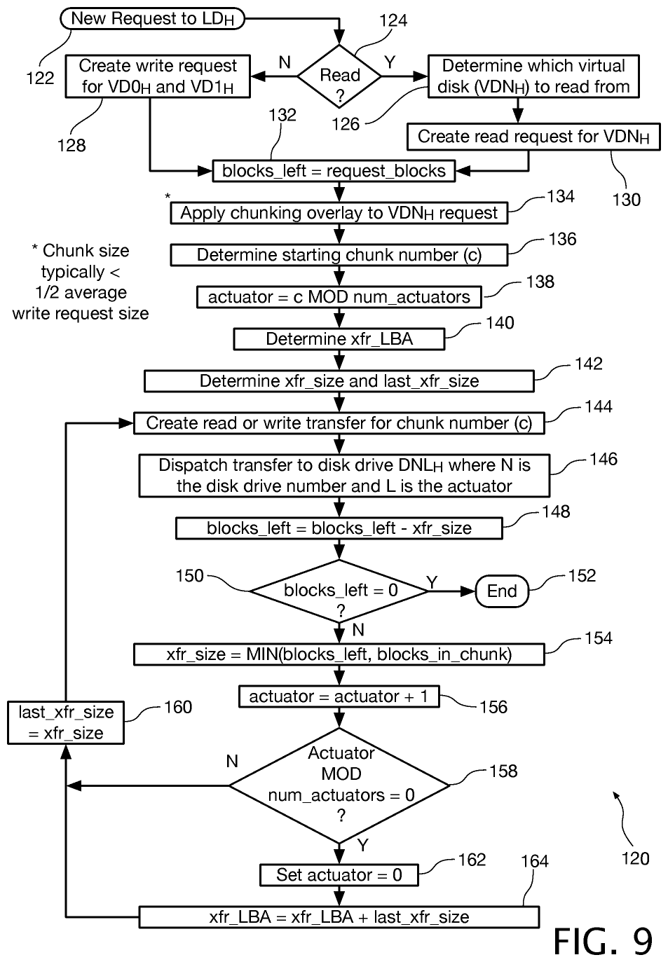

FIG. 9 is a flow diagram showing an illustrative method for performing disk transfers in a RAID 1 array in accordance with an aspect of the present invention.

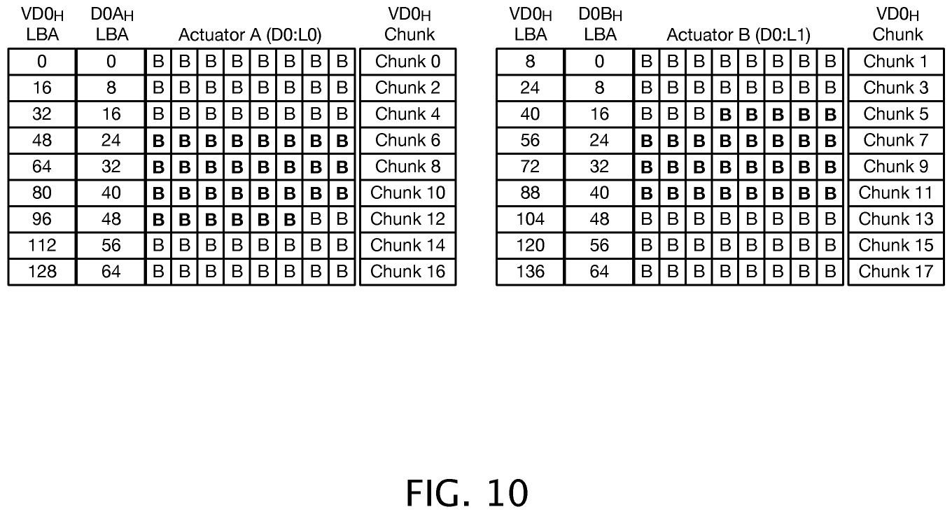

FIG. 10 is a diagram of a method 120 that that illustrates the algorithm presented by the flowchart in FIG. 9. FIG. 10 helps to illustrate how the requests are processed to take into account the possibility that the first or last block of the request may not be coincident with a chunk boundary as was depicted in FIG. 7.

FIG. 10 shows a hypothetical read request issued from the RAID 1 mapping layer to one of its virtual disk members (VD0_{H}). The request is processed into multiple read requests that are then issued to the LUNs (D0A_{H} and D0B_{H}) presented by the DAHDD. FIG. 10 shows a subset of the blocks for each of actuator A and actuator B represented by rows of B's. Each row of each actuator has 8 blocks (LBA). A row of 8 blocks on an actuator represents a chunk (blocks_in_chunk). There are 9 chunks on each actuator. This represents the chunking overlay applied to the example RAID 1 read request, as described in relation to FIG. 7. Actuator A handles even numbered chunks and actuator B handles odd numbered chunks. The total subset of blocks presented in FIG. 10 is 144. From the perspective of the RAID member virtual disk (VD0_{H}), the 144 blocks represent a contiguous storage space, blocks [0 . . . 143]. From the perspective of the DAHDD actuators (D0:L0 and D0:L1), the 144 blocks are shared by the two actuators (num_actuators), with 72 blocks each [0 . . . 71]. The example read request is depicted by the blocks presented in bold typeface. The read request begins at VD0_{H} LBA 43 (request_LBA) and extends for 59 blocks (request_blocks) through VD0_{H} LBA 101.

The notable properties of the read request are:

Request Type=read

VD0_{H} Starting LBA=block 43 as seen in the third row of the right-hand portion of FIG. 10 where the VD0_{H} LBA is seen to start at block 43 and the chunk begins (first block indicated in bold typeface) at LBA 40 and the first block of the read request is at block 43 (the fourth block position in that row).

VD0_{H} Request Blocks=59 blocks (total number of blocks indicated in bold typeface).

As depicted in FIG. 9, the first event is receipt of a new request to LD_{H} shown at reference numeral 122. The first decision made is the request type (transfer_type) to determine whether the request is a read request or a write request at reference numeral 124. In the example shown in FIG. 9, if the request is a read request, the method proceeds to reference numeral 126 where it is determined from which virtual disk (VDN_{H}) the read operation is to take place.

If the transfer is a write request, the method proceeds to reference numeral 128 where a write request is created. RAID 1 fault tolerance requires that the write be executed to both virtual disk drives (VD0_{H} and VD1_{H}) presented by the DAHDD chunking layer. In this case the DAHDD chunking algorithm of the DAHDD chunking layer will be called twice, once for each RAID 1 write request.

If the transfer is a read request, the method proceeds to reference numeral 130 where a read request is created. In RAID 1, there is an exact copy of the requested data on both virtual disk drives (VD0_{H} and VD1_{H}) presented by the DAHDD chunking layer. In this case a separate algorithm chooses to which virtual disk the request is to be sent. Persons skilled in the art will appreciate that the choice is rather arbitrary since both VD0_{H} and VD1_{H} contain the same data. Ultimately the read request is sent to the DAHDD chunking algorithm.

The method then proceeds to reference numeral 132, either from reference numeral 120 or from reference numeral 130, where the total transfer size (request_blocks) is recorded in blocks_left. The DAHDD chunking algorithm will send as many individual transfer requests to the actuators of the DAHDD as necessary until the entire transfer size is satisfied. Blocks_left will be decremented for each transfer until blocks_left is equal to 0 at which point the algorithm ends.

The method then proceeds to reference numeral 134, where the DAHDD chunking algorithm applies the chunking overlay to the virtual disk request as illustrated in FIG. 10. This results in the request being encompassed by some number of chunks. The chunk size is preferably chosen to be less than one half of an average write request size. This assures that the data is distributed to both of the actuators to as nearly as possible maximize the efficiency of the disk drive system by allowing simultaneous read and write operations from both actuators in each drive.

As shown in FIG. 7 and FIG. 10, the request is not required to start or end on a chunk boundary. The algorithm will adjust the first and last disk transfer starting LBA and transfer size accordingly for non-chunk size transfers if necessary. FIG. 10 shows an example in which the read request starts in chunk 5 and ends in chunk 12.

The method then proceeds to reference numeral 136, where the starting chunk number (c) is then calculated using integer division. Any fractional remainder is omitted. In particular:

c=request_LBA/blocks_in_chunk

In the example, c=43/8=5

The method then proceeds to reference numeral 138, where the actuator number for the first disk transfer can then be calculated using modulo arithmetic. The actuator number is the whole number remainder of the starting chunk number (c) divided by the number of actuators, i.e.:

actuator=c MOD num_actuators

In the example, actuator=5 MOD 2=1

The method then proceeds to reference numeral 140, where xfr_LBA is determined. To start the request at the correct block number on the actuator, the starting LBA, relative to VD0_{H} must be transposed to a starting LBA relative to the actuator (xfr_LBA). This can be done in three steps or fewer. All division operation are integer division and fractional remainders are omitted.

chunk_LBA=(c/num_actuators)×blocks_in_chunk

In the example, xfr_LBA=(5/2)×8=16

offset=VD0_{H} request_LBA MOD blocks_in_chunk

In the example, offset=43 MOD 8=3

xfr_LBA=chunk_LBA+offset

In the example, xfr_LBA=16+3=19

The method then proceeds to reference numeral 142, where the xfr_size and last_xfr_size are determined. The transfer size (xfr_size) for the first disk transfer must be calculated because the first transfer may begin on a block (LBA) that is not aligned to a chunk boundary. The offset calculated in the previous step is used to determine the transfer size.

xfr_size=blocks_in_chunk−offset

In the example, xfr_size=8-3=5

The variable last_xfr_size is used when the xfr_LBA needs to be adjusted when advancing to the next row of chunks.

last_xfr_size=xfr_size

In the example, last transfer size=5

The parameters required for the first transfer are now known. The parameters are used to create a new disk transfer request at reference numeral 144.

actuator=1

blocks_left=59

xfr_type=read

xfr_LBA=19

xfr_size=5

The method then proceeds to reference numeral 146, where the disk transfer request is sent to a separate algorithm to be dispatched to the DAHDD. The dispatch algorithm is common for the storage controller and used for all types of disk drives. Once the transfer has been dispatched the algorithm continues without waiting for the transfer to complete. The transfer will complete at some time in the future and the completion will be handled by a different common transfer completion algorithm.

After each transfer is dispatched parameters are updated for the next transfer.

The method proceeds to reference numeral 148 where the blocks_left parameter is decremented by the xfr_size.

The method proceeds to reference numeral 150 where it is determined whether blocks_left is equal to zero.

If blocks_left is equal to zero, the algorithm is complete and ends at reference numeral 152.

If blocks_left is non-zero, the method proceeds to reference numeral 154, where the xfr_size for the next transfer is calculated. The new transfer size will be the minimum of blocks_left or blocks_in_chunk.

xfr_size=MIN(blocks_left,blocks_in_chunk)

The actuator number is then incremented by one at reference numeral 156. This advances the algorithm to compute a transfer for the next chunk number (FIG. 10). This insures that any sufficiently large request to a virtual disk in the RAID array distributes the workload as evenly as possible to all actuators within the DAHDD thus maximizing DAHDD performance.

actuator=actuator+1

The method proceeds to reference numeral 158 where the new value of actuator is evaluated. If the actuator number becomes more than the number of actuators presented by the multi-actuator disk drive, some additional parameters need to be updated. This is referred to as wrap-around. The new value of actuator is evaluated for wrap-around with the following logic.

IF actuator MOD num_actuators is equal to zero

If the condition evaluates to false, the method algorithm proceeds to reference numeral 160 where the parameter last_xfr_size is set equal to xfr_size and the method then proceeds back to reference numeral 144 where a new transfer based on the currently updated transfer parameters is created.

If the condition evaluates to true, the method continues with additional transfer parameter modifications.

The method proceeds to reference numeral 162 where the process must advance to the next row of the chunk mapping shown in FIG. 10 by resetting the actuator number to zero, the beginning actuator in the row.

actuator=0

Next, at reference numeral 164, the xfr_LBA is advanced by the number of blocks in the last transfer (last_xfr_size). All transfers to the DAHDD, other than the first transfer of any request, must begin at a block offset aligned with a chunk boundary. The xfr_LBA is always a logical block address relative to an actuator. FIG. 10 shows that the actuator relative LBA increases by last_xfr_size for each row of chunks. The xfr_LBA remains the same for all actuators until the algorithm advances to the next row.

xfr_LBA=xfr_LBA+last_xfr_size

Next, at reference numeral 160, the variable last_xfr_size is set to equal xfr_size.

last_xfr_size=xfr_size

The method then proceeds back to reference numeral 144 where a new transfer based on the currently updated transfer parameters is created.

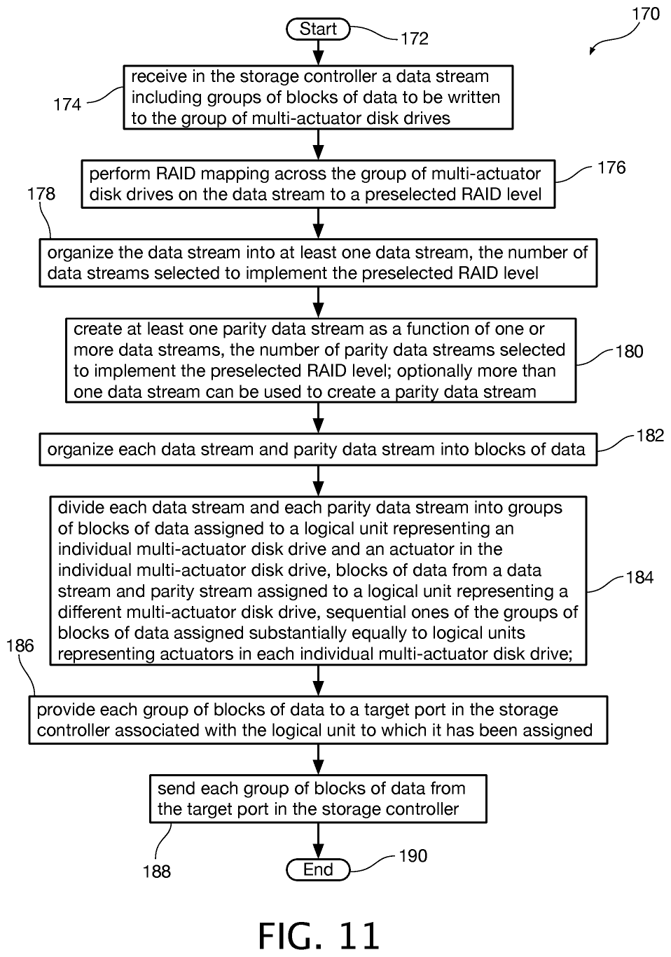

Referring now to FIG. 11, a flow diagram shows an illustrative method for operating a storage controller to write data to a RAID array of multi-actuator disk drives in accordance with an aspect of the present invention. The method begins at reference numeral 172.

At reference numeral 174, a data stream including groups of blocks of data to be written to the group of multi-actuator disk drives is received in the controller.

At reference numeral 176, RAID mapping is performed across the group of multi-actuator disk drives on the data stream to a preselected RAID level.

At reference numeral 178, the data stream is organized into at least one data stream, the number of data streams selected to implement the preselected RAID level.

At reference numeral 180, at least one parity data stream is created as a function of one or more data streams, the number of parity data streams selected to implement the preselected RAID level. In particular, for some RAID levels a parity data stream is created that is a function of data from more than one data stream. As will be appreciated by persons of ordinary skill in the art, the number of parity data streams that are created will be selected to implement a preselected RAID level. Such skilled persons will appreciate that the parity data streams are a function of the data stream. In RAID 1, the function is identity; in higher RAID levels the function may be a mathematical or logic function. In higher RAID levels the number of parity data streams may increase to more than one. For example, in RAID 5 there is one parity data stream and in RAID 6 there are two parity data streams. The creation of parity in different levels of RAID systems is well known in the art and need not be repeated here.

At reference numeral 182, each data stream and parity data stream is organized into blocks of data.

At reference numeral 184, each data stream and each parity data stream is divided into groups of blocks of data assigned to a logical unit representing an individual multi-actuator disk drive and an actuator in the individual multi-actuator disk drive, blocks of data from a data stream and parity stream are each assigned to a logical unit representing a different multi-actuator disk drive. Sequential ones of the groups of blocks of data are assigned substantially equally to logical units representing actuators in each individual multi-actuator disk drive.

At reference numeral 186, each group of blocks of data is provided to a target port in the storage controller associated with the logical unit to which it has been assigned.

At reference numeral 188, each group of blocks of data is sent from the target port in the storage controller towards the respective multi-actuator disk drive. The method ends at reference numeral 190.

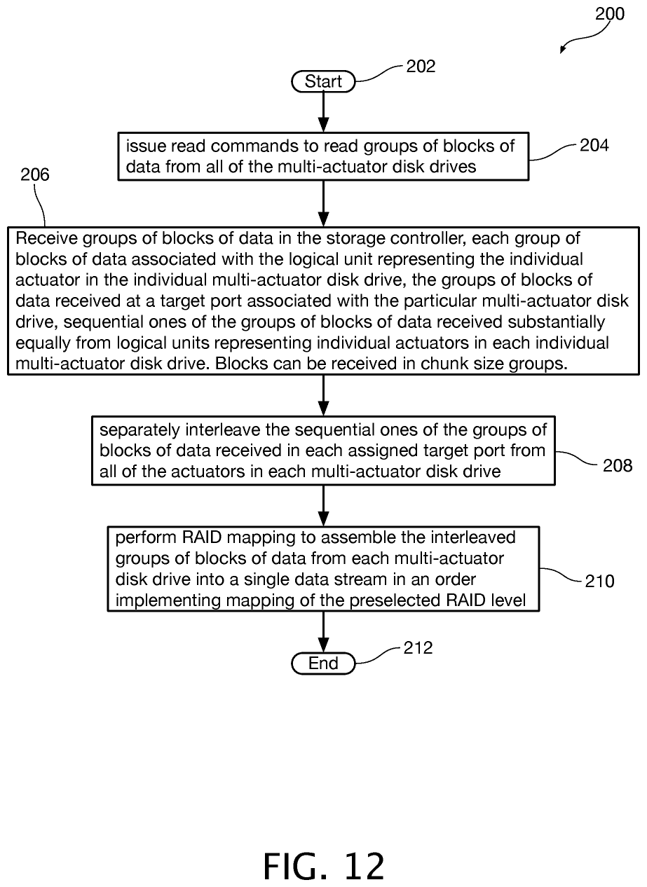

Referring now to FIG. 12, a flow diagram shows an illustrative method 200 for operating a storage controller to process data read from a RAID array of multi-actuator disk drives in accordance with an aspect of the present invention. The method begins at reference numeral 202.

At reference numeral 204, read commands are issued to read groups of blocks of data from all of the multi-actuator disk drives.

At reference numeral 206, groups of blocks of data are received in the storage controller, each group of blocks of data associated with the logical unit representing the individual actuator in the individual multi-actuator disk drive, the groups of blocks of data received at a target port associated with the particular multi-actuator disk drive, sequential ones of the groups of blocks of data received substantially equally from logical units representing individual actuators in each individual multi-actuator disk drive. Blocks can be received in chunk size groups.

At reference numeral 208, the sequential ones of the groups of blocks of data received in each assigned target port from all of the actuators in each multi-actuator disk drive are separately interleaved, i.e. data received from LUNs of each multi-actuator disk drive are interleaved without being interleaved with data received from any of the multi-actuator disk drives.

At reference numeral 210, RAID mapping is performed to assemble the separately interleaved groups of blocks of data from each multi-actuator disk drive into a single data stream in an order implementing mapping of the preselected RAID level. The method ends at reference numeral 212.

Persons of ordinary skill in the art will appreciate that the method shown in FIG. 9 can be performed much more quickly than the actual data transfers performed by the actuators A and B in response to the method shown in FIG. 9. In addition, multiple disk transfer commands may be issued to each actuator of the dual actuator disk drives. Accordingly, the actual data transfers are being simultaneously performed by both actuator A and actuator B.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A method for operating a storage controller to aggregate a group of multi-actuator disk drives in a multi-actuator disk drive system comprising:
receiving in the storage controller a data stream including data to be written to the group of multi-actuator disk drives;
performing RAID mapping across the group of multi-actuator disk drives on the data stream to a preselected RAID level;
organizing the data stream into at least one data stream, the number of data streams selected to implement the preselected RAID level;
creating at least one parity data stream, the number of parity data streams selected to implement the preselected RAID level;
organizing each of the at least one data stream and each of the at least one parity data stream into blocks of data;
dividing each of the at least one data stream and each of the at least one parity data stream into groups of blocks of data assigned to a logical unit representing an individual actuator of an individual multi-actuator disk drive of the group of multi-actuator disk drives, blocks of data from the of the at least one data stream assigned to the logical unit representing a different multi-actuator disk drive from that assigned to each of the at least one parity data stream, sequential ones of the groups of blocks of data of each of the of the at least one data stream and the at least one parity data stream assigned substantially equally to logical units representing different actuators in each individual multi-actuator disk drive;
providing each group of blocks of data to a target port in the storage controller associated with the multi-actuator disk drive to which it has been assigned; and
sending each group of blocks of data from the target port in the storage controller.

2. The method of claim 1 wherein dividing each of the at least one data stream and each of the at least one parity data stream into groups of blocks of data comprises dividing each of the at least one data stream and each of the at least one parity data stream such that each of the groups of blocks of data have an equal number of data block regions.

3. The method of claim 1 wherein:
creating at least one parity data stream comprises creating a parity data stream that is a function of data from more than one data stream.

4. The method of claim 1 wherein organizing each of the at least one data stream and each of the at least one parity data stream into blocks of data comprises organizing each of the at least one data stream and each of the at least one parity data stream into up to chunk size groups of blocks of data.

5. The method of claim 4 wherein the chunk size is chosen to be less than one half of an average write request size.

6. The method of claim 1, further comprising:
issuing read commands to read groups of blocks of data from the group of multi-actuator disk drives;
receiving groups of blocks of data at the storage controller, each group of blocks of data associated with the logical unit representing the individual actuator in the individual multi-actuator disk drive, each group of blocks of data associated with the individual multi-actuator disk drive being received at the respective assigned target port;
separately interleaving the sequential ones of the groups of blocks of data received in each assigned target port from all of the individual actuators in the associated multi-actuator disk drive; and
performing RAID mapping to assemble the separately interleaved groups of blocks of data from each multi-actuator disk drive into a single data stream in an order implementing mapping of the preselected RAID level.

7. The method of claim 6 wherein receiving groups of blocks of data in the storage controller comprises receiving chunk size groups of blocks of data at the respective assigned target port in the storage controller.

8. The method of claim 6 wherein assembling the separately interleaved groups of blocks of data from each multi-actuator disk drive into the single data stream in an order implementing mapping of the preselected RAID level comprises:
identifying first groups of blocks of data representing a data stream and identifying second groups of data representing a parity data stream; and
assembling the first groups of blocks of data representing the data stream into the single data stream.

9. A storage controller to control a group of multi-actuator disk drives in a multi-actuator disk drive system, the storage controller comprising a host port and target ports, the storage controller configured to:
receive at the host port a data stream including data to be written to the group of multi-actuator disk drives;
perform RAID mapping across the group of multi-actuator disk drives on the data stream to a preselected RAID level;
organize the data stream into at least one data stream, the number of data streams selected to implement the preselected RAID level;
create at least one parity data stream, the number of parity data streams selected to implement the preselected RAID level;
organize each of the at least one data stream and the at least one parity data stream into blocks of data;
divide each of the at least one data stream and each of the at least one parity data stream into groups of blocks of data assigned to a logical unit representing an individual actuator of an individual multi-actuator disk drive of the group of multi-actuator disk drives, blocks of data from the of the at least one data stream assigned to the logical unit representing a different multi-actuator disk drive from that assigned to each of the at least one parity data stream, sequential ones of the groups of blocks of data of each of the of the at least one data stream and the at least one parity data stream assigned substantially equally to logical units representing different actuators in each individual multi-actuator disk drive;
provide each group of blocks of data to a respective one of the target ports in the storage controller associated with multi-actuator disk drive to which it has been assigned; and
send each group of blocks of data from the target port in the storage controller.

10. The storage controller of claim 9 wherein the division of each of the at least one data stream and each of the at least one parity data stream into groups of blocks of data comprises:
dividing each of the at least one data stream and each of the at least one parity data stream such that each of the groups of blocks of data have an equal number of data block regions.

11. The storage controller of claim 9 configured to create at least one parity data stream comprises creating a parity data stream that is a function of data from more than one data stream.

12. The storage controller of claim 9 wherein the organization of each of the at least one data stream and each of the at least one parity data stream into blocks of data comprises:
organize each of the at least one data stream and each of the at least one parity data stream into up to chunk size groups of blocks of data.

13. The storage controller of claim 12 configured to choose the chunk size to be less than one half of an average write request size.

14. The storage controller of claim 9 further configured to:
receive groups of blocks of data at the storage controller, each group of blocks of data associated with the logical unit representing the individual actuator in the individual multi-actuator disk drive, each group of blocks of data associated with the individual multi-actuator disk drive being received at the respective assigned target port;
separately interleave the sequential ones of the groups of blocks of data received in each assigned target port from all of the individual actuators in the associated multi-actuator disk drive; and
perform RAID mapping to assemble the separately interleaved groups of blocks of data from each multi-actuator disk drive into a single data stream in an order implementing mapping of the preselected RAID level.

15. The storage controller of claim 14 wherein the storage controller is configured to receive chunk size groups of blocks of data at the respective assigned target port in the storage controller.

16. The storage controller of claim 14 wherein the storage controller is configured to perform RAID mapping to assemble the separately interleaved groups of blocks of data from each multi-actuator disk drive into the single data stream in the order implementing mapping of the preselected RAID level by:
identifying first groups of blocks of data representing a data stream and identifying second groups of data representing a parity data stream; and
assembling the first groups of blocks of data representing the data stream into the single data stream.
